(19) United States
(12) Patent Application Publication
(10) Pub. No.: US 2007/0147180 A1
(43) Pub. Date: Jun. 28, 2007

(54) MECHANICAL TIMEPIECE INCLUDING MEANS FOR ADJUSTING THE SHAKE OF A ROTATING PART OR WHEEL SET

(75) Inventors: Christian Rufenacht, Bienne (CH); Ivan Villar, Bienne (CH)

Correspondence Address: GRIFFIN & SZIPL, PC, SUITE PH-1, 2300 NINTH STREET, SOUTH, ARLINGTON, VA, 22204, US

(73) Assignee: ETA SA MANUFACTURE HORLOGERE SUISSE, Grenchen (CH)

(21) Appl. No.: 11/617,009

(22) Filed: Dec. 28, 2006

(30) Foreign Application Priority Data
Dec. 28, 2005 (EP) (6) 05028554.3

(51) Int. Cl. G04B 17/00

(52) U.S. Cl. 368/184

(57) ABSTRACT

The timepiece includes means for adjusting the shake of a rotating part, in particular a balance, one of whose bearings is arranged in a bar (4). This bar includes a first part (16) secured to the bottom plate (14) in a rigid and invariable manner. It further includes a second part (18) associated with means for deforming the bar (4) formed by a adjusting screw (34) one end of which rests on the bottom plate. Rotating this adjusting screw varies the distance between the second part and the bottom plate by deforming the plate (10) at zones (22 and 24) of less mechanical resistance which are provided on either side of the central part (20) of the plate (10) so as to localise the deformations generated by activating the adjusting screw (34). When the plate (10) is deformed, the central part (20) where the bearing is arranged, moves relative to the bottom plate, which thus enables the shake of the rotating part to be adjusted.

The present invention concerns a mechanical timepiece comprising means for adjusting the shake of a rotating part or wheel set, in particular the shake of a balance.

It is know from patent document CH 368 752 a device for adjusting the axial shake of the balance arbour by elastically deforming the balance cock. The balance cock is formed of a base fixed on to a bottom plate and of a plate wherein one of the two bearings wherein pivots the balance arbour, is arranged. An adjusting screw having its head on the balance's side is provided at the free end of the plate. This screw can be actuated from the top of the plate and the screw head is engaged in a groove of a second adjacent screw acting as a support for the adjusting screw. By actuating this adjusting screw the balance cock plate is deformed by varying the height of the free end thereof. The plate has a substantially constant thickness with a slight overthickness on the side of the base of the balance cock.

One can see that a deformation of the plate of the device described above generates stress in the region where the bearing arranged in the plate. Indeed the bearing is disposed in a region where the stress resulting from the deformation of the plate by means of the adjusting screw are relatively important. This also generates stress in the elements associated with the bearing, stress that can be detrimental to the free rotation of the balance arbour.

It is also known from FR 1 545 748 a device for adjusting the shake of a balance in a timepiece. The balance cock is formed here by a base fixed on to a bottom plate and a plate in the central part of which is arranged the top bearing for the balance arbour and finally by a terminal portion extending said plate. This terminal portion has a lower inclined surface. A disk arranged in an off-centered manner on a pin is provided for varying the height of the terminal portion relative to the bottom plate. The off-centered disk abuts against the lower inclined surface so that the actuation of the pin on which it is mounted results in a movement along the vertical dimension of the terminal portion. As a result, the plate of the balance cock deforms which allows the shake of the balance to be adjusted. As in the preceding document, the deformation of the balance cock plate causes relatively important stress in the central portion of this plate where the bearing is arranged. These stress are detrimental to the bearing and the various elements associated therewith. In the present case the deformation is essentially localized in the central portion as the latter portion has a lower recess provided in the region superposed to the hairspring. This results in the plate to bend in the central region; which is detrimental for the free rotation of the balance.

It is also known from CH 503 308, which concerns an adjustment device for the positioning of the height of a bar of a horological movement in particular the balance cock. The balance cock is formed of a base and a plate. The plate comprises at the opposite end of the base a screw which comprises rests on a bar on the bottom plate of the movement. By actuating this screw, the relative height of the plate is varied. This generates a deformation of this plate and thus also a variation of the position in the bearing arranged in a central portion of the plate. This shake of the balance is thus adjusted. The adjusting screw is maintained in a defined position by a second screw the head of which rests on the head of the adjusting screw. The teaching of this document is similar to that of the two above cited documents. It has the same drawbacks.

It is an object of the present invention to propose a device for adjusting the shake of a rotating part or wheel set in a timepiece, in particular a balance, which is relatively inexpensive and enables the shake of the rotating part to be adjusted quickly and efficiently, by an elastic deformation of the bar comprising the upper bearing in which pivots the arbour of this rotating part, but thereby limiting the deformation stress in the region where the bearing is arranged.

The present invention therefore concerns a mechanical timepiece fitted with a rotating part which comprises an arbour or staff one end of which pivots in a first bearing carried by a bar and the other end pivots in a second bearing arranged in a bottom plate, this timepiece comprising means for adjusting the shake of this arbour or staff of the rotating part. These adjusting means are formed on the one hand by means for securing a first part of the bar to the bottom plate, which leaves this first part in a fixed position relative to the bottom plate, and, on the other hand, by means for deforming the bar, which are arranged for varying the relative position between a second part of the bar and the bottom plate by deforming the bar, these first and second parts being provided so that actuating the deforming means generates a variation in the position of the first bearing relative to the second bearing. The timepiece comprises, between said first and second part, a zone of less mechanical resistance defining a localised deformation zone or a flexible hinge between the first and second parts. In a preferred variant, this localised deformation zone is defined by a transverse groove made on the side of the bottom face of the bar plate.

In a particular embodiment, the bar is double and the first and second parts are defined by the two bases of the bar. In this latter case, two zones of less mechanical resistance are provided, defined by two transverse grooves respectively arranged at the two ends of the plate, i.e. on the immediate periphery of the two bases.

The present invention will be described in detail hereinafter with reference to the annexed drawing, given by way of non-limiting example, in which:

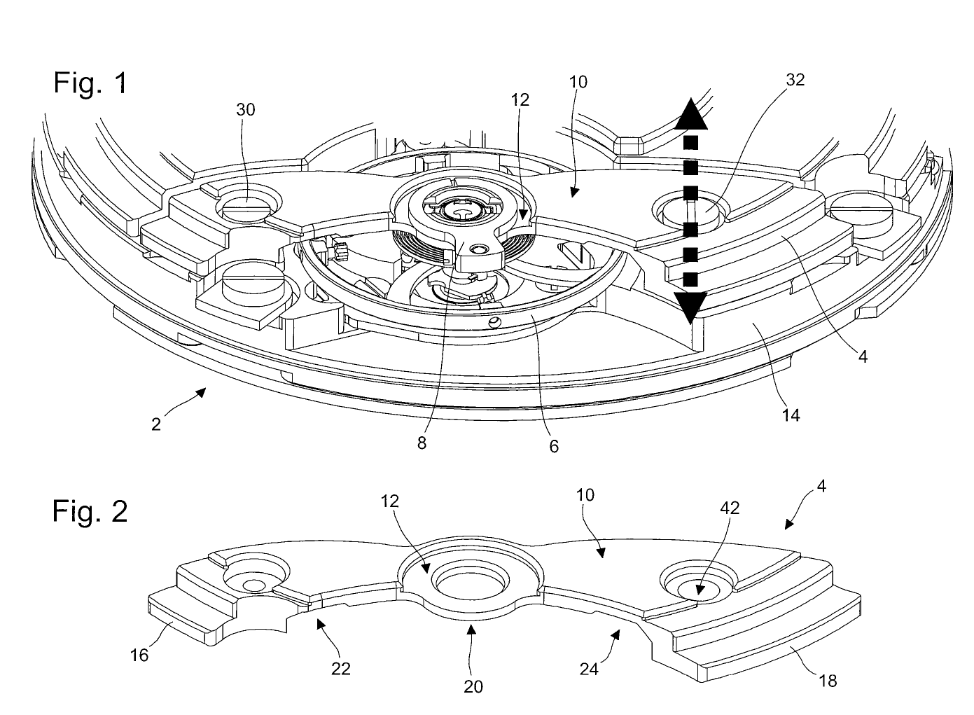

FIG. 1 is a partial perspective view of a timepiece movement having a balance bar fitted with a balance shake adjusting device according to the present invention;

FIG. 2 is a perspective view of the balance bar of the embodiment shown in FIG. 1;

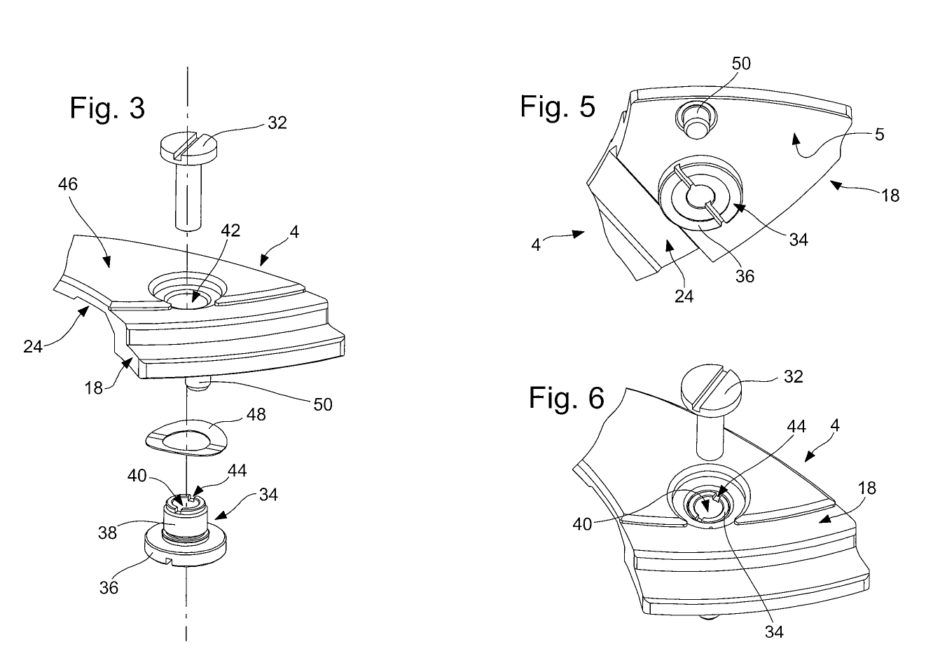

FIGS. 3 to 6 are various diagrams of a balance shake adjusting device according to the present invention fitted to the timepiece movement of FIG. 1;

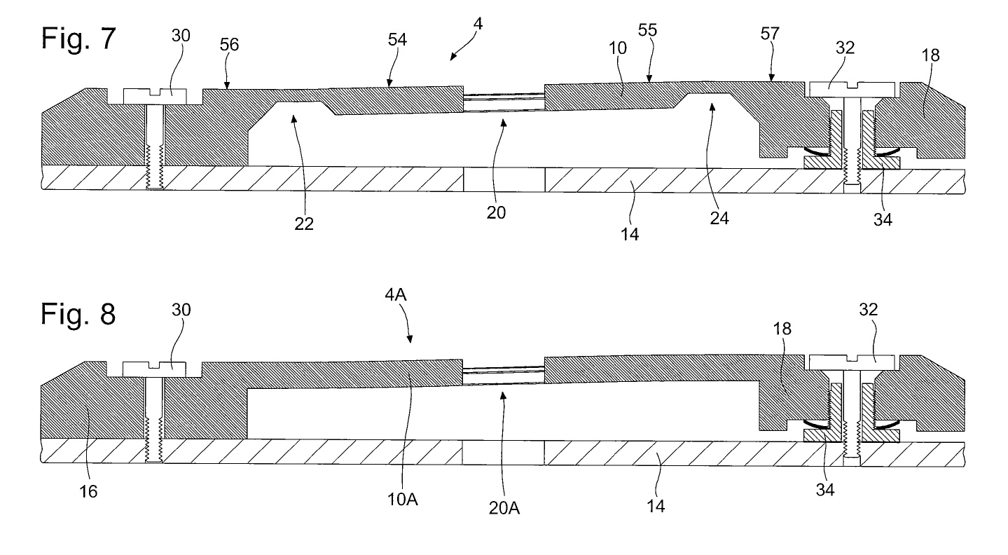

FIG. 7 is a side view of a balance bar similar to that shown in FIG. 1 and in a deformed state;

FIG. 8 is a side view of a balance bar according to a an embodiment not part of the invention;

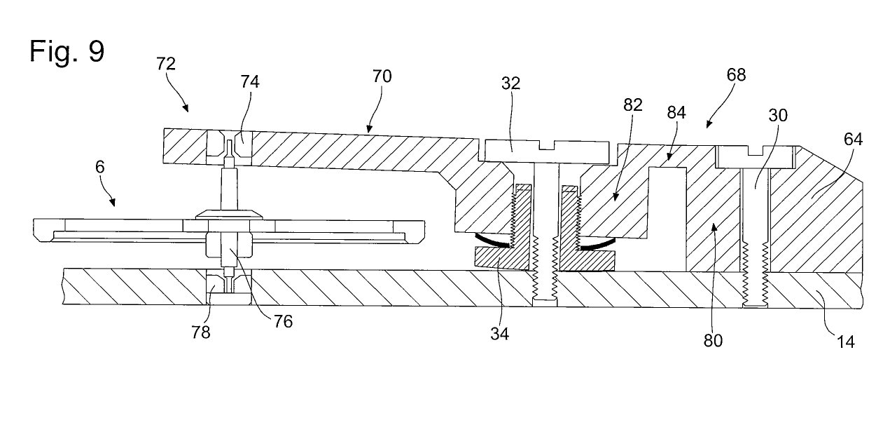

FIG. 9 shows a second embodiment of a balance bar fitted to a balance shake adjusting device according to the invention, and

FIG. 10 shows a variant of the adjusting device according to the invention.

FIG. 1 shows a first embodiment of a mechanical timepiece 2 fitted to a rotating part and comprising means for adjusting the shake of this rotating part in accordance with the present invention.

The first embodiment of the invention will be described hereinafter with reference to FIGS. 1 to 7. The bar in this embodiment is a balance bar 4 and the rotating part is a balance 6. In a conventional manner, balance 6 comprises a staff one end of which pivots in a first bearing carried by the plate 10 of the balance bar. The first bearing is arranged in an aperture of a balance spring stud holder 8 with a shock-absorber device known to those skilled in the art. The balance spring stud holder 8 rests on the central seat 12 of bar 4. The second end of the balance staff pivots in a second bearing arranged in a bottom plate 14 of timepiece 2.

The balance bar 4 is a double bar formed of two bases 16 and 18 respectively arranged on either side of plate 10 and thus of the first bearing arranged in the central part 20 of said bar. Seat 12 for the balance spring stud holder has in this variant a smaller thickness than that of plate 10 in the two parts thereof directly adjacent to the seat. According to the invention, bar 4 includes two zones of less mechanical resistance 22 and 24, respectively in the two end regions of plate 10, i.e. respectively between the two bases 16 and 18 and the central part 20 carrying the first bearing for the balance staff. These two zones of less mechanical resistance are each formed by a transverse zone defined by a groove of a certain length. We will return to the function of these zones of less mechanical resistance hereinafter.

On the one hand a rigid securing screw 30 of a first part 16 of bar 4, onto the bottom plate is provided, this first part being defined in this embodiment by base 16. On the other hand, the second base 18 of bar 4 defines a second part secured to said bottom plate by means of a tightening screw 32. This second part 18 is associated with means 34 for elastically deforming bar 4. The deformation means are formed here by a screw 34 of relatively large diameter and pierced at the centre thereof. This adjusting screw 34 includes a flat head 36 provided with a slot for screwing in the screw from the bottom part of bar 4. Adjusting screw 34 further includes a cylinder 38 having an outer threading with a fine pitch in order to vary finely the distance between the external surface 37 of head 36 and the bottom surface 5 of bar 4. The hole 40 that passes through screw 34 has a larger diameter than that of tightening screw 32 so that the latter can be freely inserted into through hole 40.

Screw 34 is screwed into a hole 42 passing through base 18 of bar 4. Hole 42 has an enlarged portion in the top part of base 18 with a substantially flat annular surface acting as a stop member for the head of tightening screw 32. The bottom end of screw 32 is screwed into bottom plate 14 in order to secure base 18 to bottom plate 14.

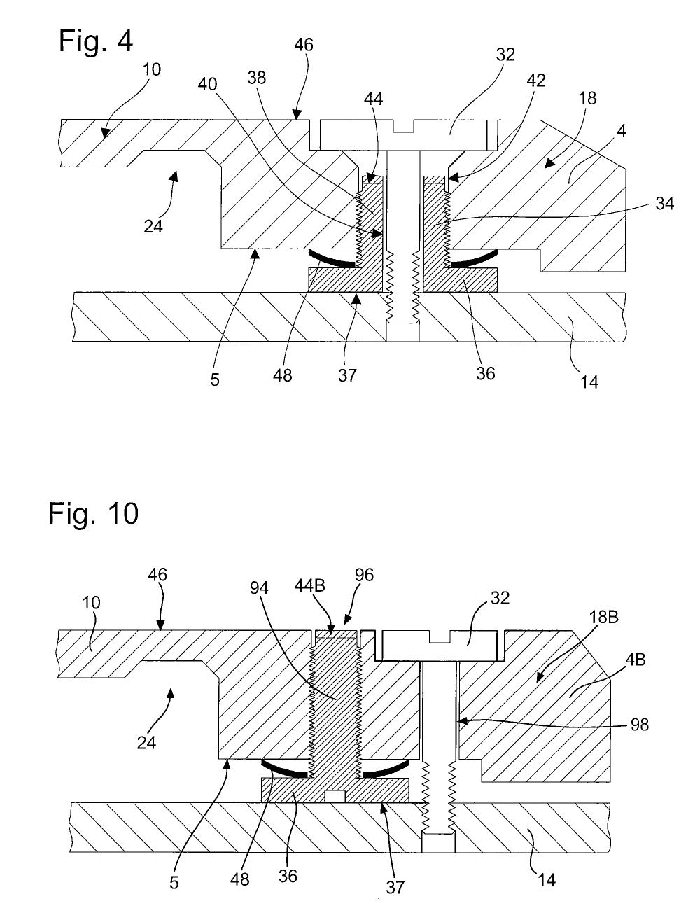

Adjusting screw 34 has, at its top end, opposite head 36, a top annular part with two diametrically opposite slots 44 arranged to allow a screwdriver to be inserted therein in order to rotate said adjusting screw 34 from the top face 46 of the bar in the absence of tightening screw 32, as is shown in particular in FIGS. 4 and 6. A friction spring, having the shape of a bent washer 48 is arranged between head 36 of screw 34 and the bottom surface 5 of base 18. A positioning pin 50 is provided in order to position base 18 in the general plane of timepiece movement 2.

Rotating adjusting screw 34 varies the relative distance between base 18 and bottom plate 14 given that the bottom surface 37 of head 36 rests on said bottom plate. Tightening screw 32 is removed in order to adjust the height of base 18 from the top surface 46 of bar 4 through the through aperture 42. In order to do this, the watchmaker will hold screw 34 abutting against bottom plate 14, for example by using an appropriate tool, if this proves necessary. Given that base 16 is secured to the bottom plate in an invariable position, actuating adjusting screw 34 generates a deformation of bar 4 as is shown in FIG. 7. Thus, actuating adjusting screw 34 varies the distance between base 18 and bottom plate 14 and plate 10 is deformed such that the central zone 20, where the top bearing for the balance staff is situated, also undergoes a movement thereby adjusting the shake of the balance.

As already described previously, plate 10 comprises, at its two end parts, two zones of less mechanical resistance 22 and 24, which each define a localised deformation zone or flexible hinge between the two bases 16 and 18. These localised deformation zones are obtained by machining two grooves on the bottom side of plate 10, which define transverse zones of bar 4 having smaller thickness than the two adjacent regions 54 and 56, respectively 55 and 57. The deformation of the bar is thus essentially localised in the two transverse zones 22 and 24, such that bases 16 and 18 undergo almost no stress due to deformation and central part 20 of plate 10 remains substantially flat. Moreover, these zones 22 and 24 decrease the overall stresses generated in balance bar 4 when base 18 is moved in height relative to base 16. The adjustment of the balance shake can generate here a certain inclination of central part 20 of plate 10, but this inclination remains small.

Owing to the invention, seat 12 for the balance spring stud remains flat and subjected to relatively little tension. It should be noted that the arrangement of the zones of less resistance 22 and 24 are all the more necessary if seat 12 of the balance spring stud is formed by machining plate 10. Thus, seat 12 has a smaller thickness than the regions 54 and 55 peripheral to said seat 12, which makes the central zone 20 easier to deform. Consequently, in the device shown in FIG. 8, in the absence of the transverse zones of the invention, bar 4A has a substantially S-shaped deformation, the deformation of plate 10a being situated substantially at the level of its central part 20A. This central portion strongly undergoes then the deformation stress. This is detrimental to the bearing and the rotation of the wheel set one end of which pivots in thus bearing. Those skilled in the art could devise other bars and other means for regulating the balance shake.

The shake adjusting device according to the present invention is relatively simple and thus inexpensive. Moreover, the coaxial arrangement of the tightening screw 32 and the adjusting screw 32 does not increase the space requirement of the bar.

The shake adjusting device is easily mounted simply by screwing in adjusting screw 34 from the bottom face 5 of bar 4 until its head is approximately at the defined height. Next, the bar can be assembled to the bottom plate with the balance mounted in the two bearings associated therewith. Then, the shake of the balance (or another rotating part) can be regulated simply by rotating screw 34 using slot 44 provided at its top end opposite head 36, this top end being accessible by a tool from the top face 46 of the bar through aperture 42 passing through base 18. Once the adjustment is made, screw 32 is inserted into through hole 40 of regulating screw 34 and tightened so as to fix base 18 rigidly to bottom plate 14. The resilient washer 48 holds adjusting screw 34 in the desired position. Once the distance between the two bearings has been finely adjusted by means of adjusting screw 34, the system for adjusting the height of bar 4 is concealed and the bar is securely fixed to the bottom plate.

It should be noted that the present invention can also apply to a timepiece movement fitted with a tourbillon and wherein the shake of the tourbillon carriage is adjusted using the device of the present invention associated with the tourbillon bar carrying one of the two bearings in which the tourbillon carriage pivots.

FIG. 9 shows schematically a cross-section of a second embodiment of a timepiece according to the present invention.

In this embodiment, the balance bar 64 is of the simple type, i.e. with one base 68 arranged at one end of plate 70, which has, at its other free end 72, a first bearing 74 in which the staff 76 of the balance 6 pivots. The second end of staff 76 pivots in a bearing 78 arranged in the bottom plate. Bearings 74 and 78 are shown schematically in FIG. 9. In a conventional manner, bearing 74 is generally associated with a shock-absorber device known to those skilled in the art.

The means for adjusting the shake of balance 6 are obtained, in accordance with the principle of the present invention, by deforming bar 64 generating a variation in the inclination of plate 70 and consequently a variation in the distance between bearings 74 and 78. In order to do this, base 68 comprises two distinct parts 80 and 82 separated by an intermediate zone 84 defining a transverse zone of less mechanical resistance allowing localised deformation between parts 80 and 82 of the base. The part 80, which is the farthest from bearing 74 is rigidly secured to bottom plate 14 by means of a securing screw 30. This first part 80 is held in a fixed and invariable position relative to bottom plate 14 when screw 30 is tightened. The second part 82 is fitted with a device for varying the position of this part 82 relative to bottom plate 14, which generates deformation of the bar in particular in intermediate region 84. Thus, the relative position between the two parts 80 and 82 of bar 64 can be varied, which generates a movement of plate 70 and in particular of bearing 74 relative to bottom plate 14. The bar deformation means acting on the second part 82 are similar to those described within the scope of the first embodiment. They will not, therefore, be described again here.

FIG. 10 shows another embodiment of the means for deforming bar 4B. This alternative can apply to both embodiments of a timepiece according to the invention described hereinbefore. However, the embodiment shown in FIG. 10 corresponds to a case with a double bar according to the first embodiment shown in FIG. 1. Bar 4B thus includes a base 18B similar to the base 18 of the embodiment of FIG. 1.

The embodiment of FIG. 10 essentially differs from that described with reference to the preceding Figures in that the screw securing the base 18B to bottom plate 14 is not coaxial to the screw 94 adjusting the shake of the balance. Indeed, screw 94, used for deforming bar 4B and varying the relative position between base 18B and bottom plate 14, is arranged between tightening screw 32 and plate 10 of bar 4B. It will be immediately clear that this screw 94 can also be arranged on the other side of screw 32. Adjusting screw 94 differs from screw 34 of the other embodiments in that it has no through hole and in that its top end 96 is visible and accessible from the top face 46 of bar 4B, whereas tightening screw 32 is set in place in the through hole 98 made in base 18B. The end 96 of screw 94 has a slot 44B allowing screw 94 to be rotated and thus the distance between base 18b and bottom plate 14 to be varied. In order to increase this distance, the watchmaker will obviously unscrew screw 32.

This latter embodiment of the balance shake adjusting device has certain advantages but also certain drawbacks. Deformation means 94, also formed here by a single element, can be activated by leaving securing screw 32 in place in its hole 98. The adjusting screw 94 is solid and thus less expensive than the screw 34 of the first embodiment. However, this embodiment requires more space and in particular the dimensions of base 18B have to be greater than the dimensions of base 18 of the first embodiment.

Finally, it will be mentioned that in another embodiment, similar to the second embodiment shown in FIG. 9, a single screw similar to the screw 94 shown in FIG. 10 can replace the adjusting screw 34 associated with tightening screw 32. In such case, bar 64 will be machined so that adjusting the balance shake always imperatively requires adjusting screw 94 to be unscrewed in order to move bearing 74 away from bearing 76. Thus, head 36 of screw 94 will remain abutting against the surface of bottom plate 14 via the mechanical resistance due to the deformation of bar 64. The section of intermediate part 84 will be selected to allow this zone to be deformed by unscrewing adjusting screw 94, while guaranteeing that sufficient force is exerted on head 36 to hold it pressed against bottom plate 14 when screw 30 is tightened.

What is claimed is:

1. A mechanical timepiece fitted with a rotating part, which includes an arbour one end of which pivots in a first bearing carried by a bar and the other end of which pivots in a second bearing arranged in a bottom plate, said timepiece including means for adjusting the shake of said rotating part, which are formed on the one hand by means for securing a first part of said bar to the bottom plate, which leaves said first part in a fixed relation relative to said bottom plate, and on the other hand by means for deforming the bar which are arranged for varying the relative position between a second part of said bar and said bottom plate by deforming said bar, said first and second parts of said bar being provided such that actuating said bar deformation means generates a variation in the distance between said first bearing and said second bearing, wherein it includes, between said first and second parts of said bar, at least one zone of less mechanical resistance situated outside the portion where said first bearing is arranged and defining a localised deformation zone or a flexible hinge between said first and second parts.

2. Timepiece according to claim 1, wherein said zone of less mechanical resistance is formed by a transverse zone of said bar whose thickness is smaller than the two adjacent regions respectively located on either side of said transverse zone.

3. Timepiece according to claim 1, wherein said first and second parts are respectively located on one side and the other side of said first bearing, and wherein two zones of less mechanical resistance are provided, respectively located between the first part and the first bearing and the second part and the second bearing.

4. Timepiece according to claim 3, wherein said bar comprises a plate (10) in which said first bearing and said two zones of less mechanical resistance are arranged.

5. Timepiece according to claim 1, wherein said means for deforming said bar are arranged to be actuated by the variation in the position of a single element.

6. Timepiece according to claim 5, wherein said deformation means are formed by a screw for adjusting the distance between said second part of said bar and said bottom plate, said adjusting screw having a first end abutting against said bottom plate and the second end thereof accessible from the top face of said bar opposite to said bottom plate, the second end having a shape adapted to a tool allowing said regulating screw to be rotated to vary the distance between the second part of the bar and the bottom plate.

7. Timepiece according to claim 1, wherein said bar is a balance bar or tourbillon bar and said rotating part is a balance or a tourbillon carriage.
